(19) United States
(12) Patent Application Publication
(10) Pub. No.: US 2010/0231142 A1
(43) Pub. Date: Sep. 16, 2010

(54) DRY CELL HOLDER AND FLASHLIGHT HAVING THE SAME

(76) Inventor: Sang-Yeon Yoon, Busan (KR)

Correspondence Address: HARNESS, DICKEY & PIERCE, P.L.C., P.O. BOX 8910, RESTON, VA, 20195, US

(21) Appl. No.: 12/720,191

(22) Filed: Mar. 9, 2010

(30) Foreign Application Priority Data
Mar. 10, 2009 (KR) 10-2009-0020106

(51) Int. Cl. H05B 39/00; H01M 2/10; F21L 4/02

(52) U.S. Cl. 315/312; 429/99; 362/184

(57) ABSTRACT

A dry cell holder may include a cylindrical body, an anode terminal, a cathode terminal, a switching signal terminal, a first electrode terminal and a second electrode terminal. The cylindrical body may have a front plate and a rear plate. The anode terminal may be formed on the front plate. The cathode terminal may be formed on the front plate. The switching signal terminal may be formed on the front plate. The first electrode terminal may be formed on the rear plate. The first electrode terminal may be connected to the anode terminal. The first electrode terminal may be connected to the cathode terminal. The second electrode terminal may be formed on the rear plate. The second electrode terminal may be connected to the switching signal terminal.

### CROSS-RELATED APPLICATION

This application claims priority under 35 USC §119 to Korean Patent Application No. 2009-20106, filed on Mar. 10, 2009 in the Korean Intellectual Property Office (KIPO), the contents of which are herein incorporated by reference in their entirety.

### BACKGROUND

1. Field

Example embodiments relate to a dry cell holder and a flashlight having the same. More particularly, example embodiments relate to a cylindrical dry cell holder configured to receive three AAA dry cells, and a flashlight having the dry cell holder.

2. Description of the Related Art

Generally, a flashlight may include a lamp, a dry cell, a switch and a case. The lamp, the dry cell and the switch may be received in the case. The case may have a cylindrical shape for allowing a user to easily carry and hold with a hand.

Recently, the lamp may be converted into a light emitting diode (LED) having low power consumption from a filament bulb. Thus, the dry cell may also be converted into a small AAA dry cell having length of about 44.5 mm and a diameter of about 10.5 mm from a large AA dry cell having a length of about 51 mm and a diameter of about 13.5 mm to about 14.5 mm.

In order to emit a sufficient light from the LED without a booster, it may be required to serially connect the three AAA dry cells from one another. However, when the three AAA dry cells are serially connected from one another, the flashlight may have a length of no less than about 150 mm. This flashlight may be uneasy to carry.

Thus, the three AAA dry cells may be received in a cylindrical dry cell holder having a length of about 50 mm. The cylindrical dry cell holder may allow an easily carryable flashlight to have a length of about 100 mm with a sufficient voltage for driving the LED.

Korean Utility Model No. 384989 and U.S. Patent Publication Nos. 2005/0254234 and 2005/0036307 disclose cylindrical dry cell holders configured to receive three AAA dry cells.

A conventional cylindrical dry cell holder may have a structure configured to receive three AAA dry cells along three directions while keeping an angle of about 120° between them. Therefore, a front plate, a rear plate and a supporting plate of the cylindrical dry cell holder may not be manufactured once by an injection molding. As a result, the front plate and the rear plate may be assembled with the supporting plate using screws. Screwed portions of the cylindrical dry cell holder may be damaged. Further, when the screws become loose, a contact fail between the dry cell and a terminal in the cylindrical dry cell holder may be generated. Furthermore, when the cylindrical dry cell holder or the flashlight is dropped, the cylindrical dry cell holder may be disassembled or broken.

Moreover, a lamp of a flashlight may receive an electric current from a dry cell through a conductive body. Thus, in order to display an illumination state, an on/off state of the lamp, etc., a switch for generating control signals may be installed at a portion of the conductive body adjacent to the lamp. As a result, displays of various lamp signals may be limited.

### SUMMARY

Example embodiments provide a dry cell holder having a function of transmitting switching signals to a front lamp irrespective of a body or a cable, a strong strength against damage and a light weight and giving an improved grip feeling.

Example embodiments also provide a flashlight including the above-mentioned dry cell holder capable of accomplishing selective switching of a high luminance illumination, a color illumination, a laser pointer illumination and an on/off illumination, and diffusion and focusing of a light beam.

According to some example embodiments, there is provided a dry cell holder. The dry cell holder may include a cylindrical body, an anode terminal, a cathode terminal, a switching signal terminal, a first electrode terminal and a second electrode terminal. The cylindrical body may have a front plate and a rear plate to receive three dry cells. The anode terminal may be formed on an outer surface of the front plate. The cathode terminal may be formed on the outer surface of the front plate. The switching signal terminal may be formed on the outer surface of the front plate. The first electrode terminal may be formed on an outer surface of the rear plate. The first electrode terminal may be electrically connected to the anode terminal to serially connect the three dry cells from one another. The first electrode terminal may be electrically connected to the cathode terminal. The second electrode terminal may be formed on the outer surface of the rear plate. The second electrode terminal may be electrically connected to the switching signal terminal for allowing switching signals, which are generated between the first electrode terminal and the second electrode terminal, to transmit a front of the cylindrical body.

According to some example embodiments, there is provided a dry cell holder. The dry cell holder may include a front plate, a rear plate and a supporting plate. The supporting plate may be connected between the front plate and the rear plate. The supporting plate may be integrally formed with the front plate and the rear plate to form a cylindrical body. The cylindrical body may have a first receiving space configured to receive two dry cells along a first direction, and a second receiving space configured to receive one dry cell along a second direction substantially opposite to the first direction. The first receiving space may be in fluidic communication with a first opening formed through a first outer surface of the cylindrical body. The second receiving space may be in fluidic communication with a second opening formed through a second outer surface of the cylindrical body opposite to the first outer surface.

According to some example embodiments, there is provided a dry cell holder. The dry cell holder may include a cylindrical body, a front terminal cap, a rear terminal cap, and first and second cables. The cylindrical body may have a first receiving space configured to receive two dry cells and being in fluidic communication with a first opening formed through a first outer surface of the cylindrical body, a second receiving space configured to receive one dry cell along a second directions substantially opposite to the first direction and being in fluidic communication with a second opening formed through a second outer surface of the cylindrical body opposite to the first outer surface, and first and second grooves formed at both sides of the second receiving space. The front terminal cap may be assembled with a front of the cylindrical body. The front terminal cap may include a plurality of resilient contact pins that have different radii from a center point of the front terminal cap to provide a front of the cylindrical body with a first electrode, a second electrode and a third electrode. The rear terminal plate may be assembled with a rear of the cylindrical body to provide a rear of the cylindrical body with concentrically arranged first and second electrodes. The first and second cables may be received in the first and second grooves, respectively, to electrically connect the first and second electrodes of the rear terminal plate with the first and second electrodes of the front terminal cap.

According to some example embodiments, there is provided a dry cell holder. The dry cell holder may include a cylindrical body, a first resilient conductive member, a first conductive plate, a second conductive plate, a second resilient conductive member, a third resilient conductive member, a front circuit substrate, a rear circular circuit substrate, a first cable, a second cable, a front cap and resilient contact terminals. The cylindrical body may have a first receiving space configured to receive first and second AAA dry cells and being in fluidic communication with a first opening formed through a first outer surface of the cylindrical body, a second receiving space configured to receive a third AAA dry cell along a second directions substantially opposite to the first direction and being in fluidic communication with a second opening formed through a second outer surface of the cylindrical body opposite to the first outer surface, and first and second grooves formed at both sides of the second receiving space. The first resilient conductive member may be installed at an inner surface of a front plate in the cylindrical body configured to form the first receiving space. The first resilient conductive member may have one end configured to resiliently make contact with a cathode of the first AAA dry cell in the first receiving space and another end configured to resiliently make contact with an anode of the second AAA dry cell in the first receiving space. The first conductive plate may be installed at an inner surface of the front plate in the cylindrical body configured to form the second receiving space. The first conductive plate may have one end configured to make contact with an anode of the third AAA dry cell and another end extending to an outside of the cylindrical body. The second conductive plate may be installed at an inner surface of a rear plate in the cylindrical body configured to form the first receiving space. The second conductive plate may have one end configured to make contact with an anode of the first AAA dry cell and another end extending to the inner surface of the rear plate. The second resilient conductive member may be installed at an inner surface of the rear plate in the cylindrical body configured to form the second receiving space. The second resilient conductive member may have one end configured to make contact with another end of the second conductive plate and another end configured to resiliently make contact with a cathode of the third AAA dry cell in the second receiving space. The third resilient conductive member may be installed at an inner surface of the rear plate in the cylindrical body configured to form the first receiving space. The third resilient conductive member may have one end configured to resiliently make contact with a cathode of the second AAA dry cell in the first receiving space and another end extending to the outside of the cylindrical body. The front circuit substrate may be configured to make contact with the front plate of the cylindrical body. A central conductive pattern, a large conductive pattern and a small conductive pattern having different radii from a center point of the front circuit substrate may be formed on a front surface of the front circuit substrate. The central conductive pattern may be electrically connected to another end of the first conductive plate. The rear circular circuit substrate may be configured to make contact with the rear plate of the cylindrical body. A central conductive pattern, a large annular conductive pattern and a small annular conductive pattern may be concentrically arranged on a rear surface of the rear circular circuit substrate. The central conductive pattern and the large annular conductive pattern may be electrically connected to another end of the third conductive plate. The first cable may be received in the first groove. The first cable may have one end electrically connected to the large conductive pattern of the front circuit substrate and another end electrically connected to the large annular conductive pattern of the rear circular circuit substrate. The second cable may be received in the second groove. The second cable may have one end electrically connected to the small conductive pattern of the front circuit substrate and another end electrically connected to the small annular conductive pattern of the rear circular circuit substrate. The front cap may be assembled with the front plate of the cylindrical body to cover the front circuit substrate. The front cap may have three holes that may have different radii from a center point of the front cap. The resilient contact terminals may be configured to resiliently make contact with the conductive patterns through the holes.

According to some example embodiments, there is provided a flashlight. The flashlight may include a cylindrical body, a head, a rear cap and a dry cell holder. The head may be combined with a front of the cylindrical body. The head may include at least one light emitting diode (LED). The rear cap may be combined with a rear of the cylindrical body to generate a switching signal. The dry cell holder may be inserted into the cylindrical body and configured to receive three dry cells to provide the head with the switching signal and a power of the dry cells. The dry cell holder may include a front plate, a rear plate and a supporting plate integrally formed with one another.

According to some example embodiments, there is provided a flashlight. The flashlight may include a cylindrical body, a head, a rear cap, a dry cell holder. The head may be combined with a front of the cylindrical body. The head may include at least one light emitting diode (LED) and a lens linearly moved in forward and backward directions between the LED and a focal point. The rear cap may be combined with a rear of the cylindrical body to generate a switching signal. The dry cell holder may be inserted into the cylindrical body and configured to receive three dry cells to provide the head with the switching signal and a power of the dry cells. The dry cell holder may include a front plate, a rear plate and a supporting plate integrally formed with one another.

According to some example embodiments, a rear switching signal may be transmitted to the head through the dry cell holder, so that the flashlight may have various displays and high quality. Further, because a current path through the body may not be required, the body may include a nonconductor such as wood, plastic, etc., so that the flashlight may have a light weight and good appearance. Furthermore, the dry cell holder may have one body including the front plate, the rear plate and the supporting plate by the injection molding, so that the dry cell holder may have improved durability.

### BRIEF DESCRIPTION OF THE DRAWINGS

Example embodiments will be more clearly understood from the following detailed description taken in conjunction with the accompanying drawings. FIGS. 1 to 17 represent non-limiting, example embodiments as described herein.

FIG. 1 is a perspective view illustrating a dry cell holder in accordance with some example embodiments;

FIG. 2 is an exploded perspective view illustrating the dry cell holder in FIG. 1;

FIG. 3 is a rear view illustrating the dry cell holder in FIG. 1;

FIG. 4 is a cross-sectional view taken along a line A-A′ in FIG. 1;

FIG. 5 is a cross-sectional view taken along a line B-B′ in FIG. 1;

FIG. 6 is an exploded perspective view illustrating a flashlight in accordance with some example embodiments;

FIG. 7 is a cross-sectional view illustrating the flashlight in FIG. 6;

FIG. 8 is an exploded perspective view illustrating a lamp holder of the flashlight in FIG. 6;

FIG. 9 is an exploded perspective view illustrating a rear cap of the flashlight in FIG. 6;

FIG. 10 is a circuit diagram illustrating the flashlight in FIG. 6;

FIG. 11 is a cross-sectional view illustrating a flashlight in accordance with some example embodiments;

FIG. 12 is a circuit diagram illustrating the flashlight in FIG. 11;

FIG. 13A is a perspective view illustrating a flashlight in accordance with some example embodiments;

FIG. 13B is a front view illustrating a lamp arrangement of the flashlight in FIG. 13A;

FIGS. 13C to 13F are front views illustrating a lamp arrangement of a flashlight in accordance with some example embodiments;

FIG. 13G is a perspective view illustrating a flashlight in accordance with some example embodiments;

FIG. 13H is a front view illustrating a lamp arrangement of the flashlight in FIG. 13G;

FIG. 14 is a cross-sectional view illustrating a flashlight focusing a light in accordance with some example embodiments;

FIG. 15 is a cross-sectional view illustrating the flashlight in FIG. 14 diffusing a light;

FIG. 16A is a cross-sectional view illustrating a flashlight focusing a light in accordance with some example embodiments;

FIG. 16B is an enlarged cross-sectional view illustrating a portion “C” in FIG. 16A; and

FIG. 17 is a cross-sectional view illustrating a flashlight focusing a light in accordance with some example embodiments.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

### Dry Cell Holder

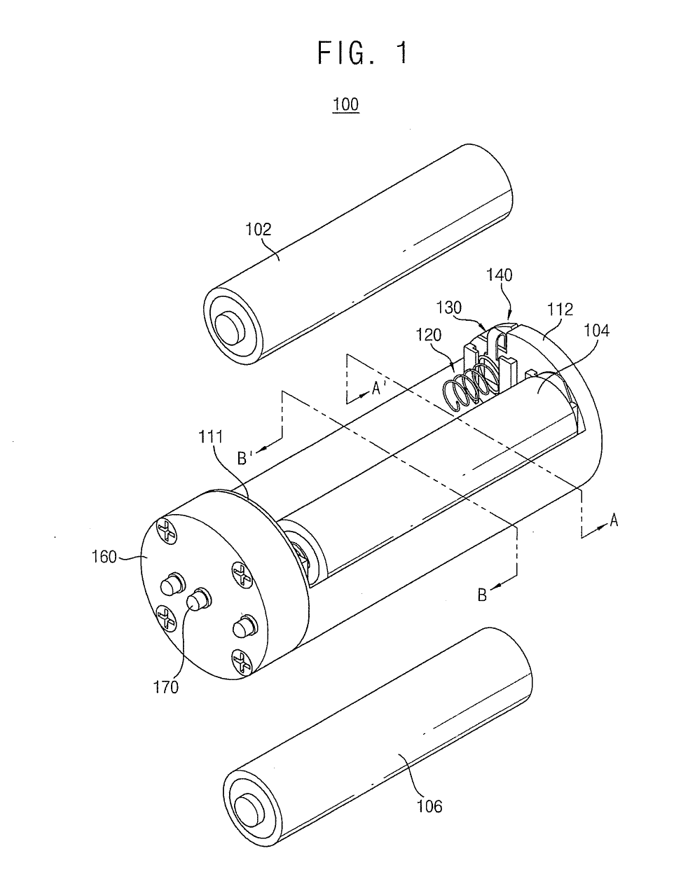

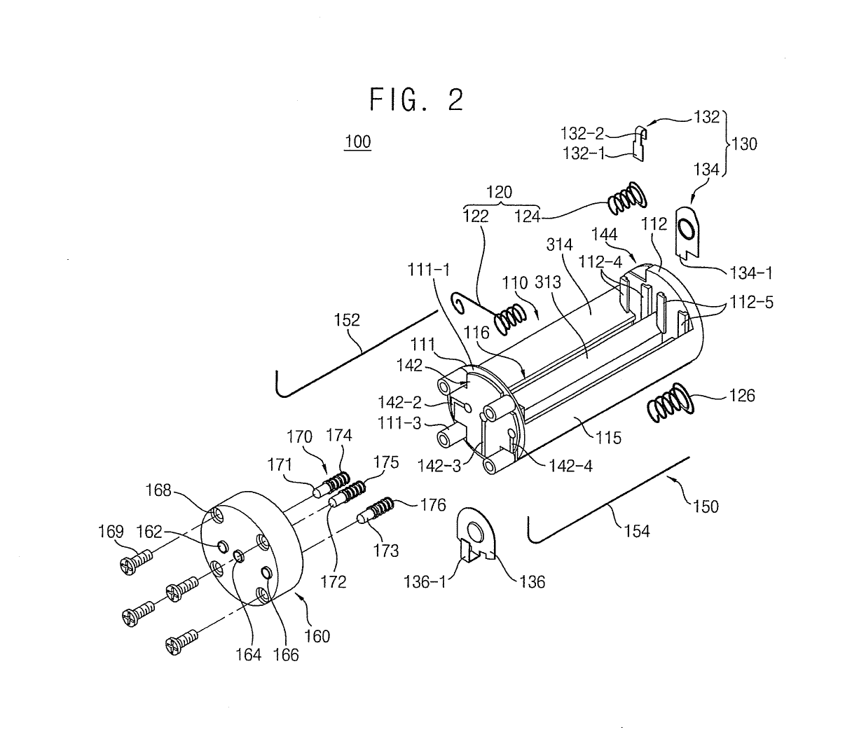

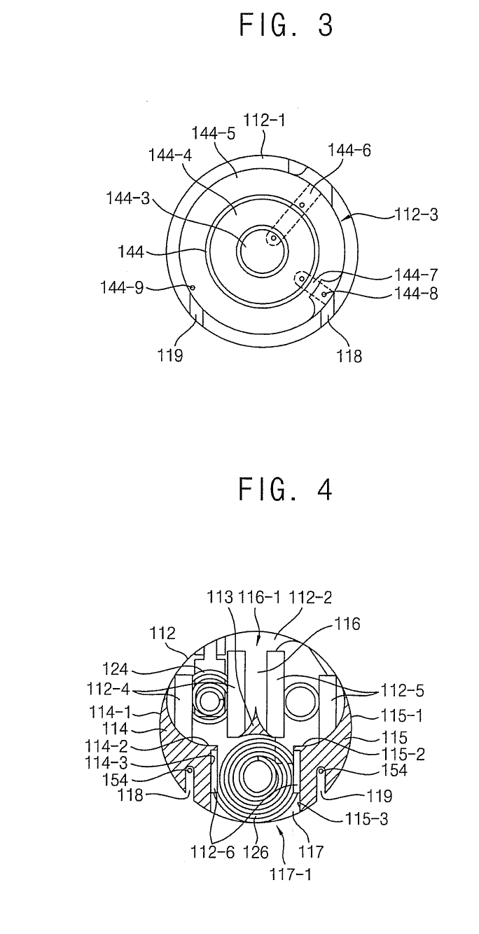

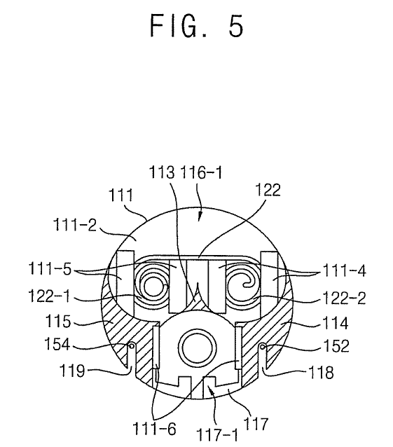

FIG. 1 is a perspective view illustrating a dry cell holder in accordance with some example embodiments, FIG. 2 is an exploded perspective view illustrating the dry cell holder in FIG. 1, FIG. 3 is a rear view illustrating the dry cell holder in FIG. 1, FIG. 4 is a cross-sectional view taken along a line A-A′ in FIG. 1, and FIG. 5 is a cross-sectional view taken along a line B-B′ in FIG. 1.

Referring to FIGS. 1 to 5, a dry cell holder 100 of this example embodiment may include a cylindrical body 110, resilient members 120, conductive plates 130, terminal substrates 140, cables 150, a front cap 160 and resilient contact pins 170.

The cylindrical body 110 may include a front plate 111, a rear plate 112, a central supporting plate 113, a left supporting plate 114 and a right supporting plate 115. In some example embodiments, the front plate 111, the rear plate 112 and the supporting plates 113 and 114 may be formed using plastic. Further, the front plate 111, the rear plate 112 and the supporting plates 113 and 114 may be integrally formed to constitute the cylindrical body 110. An upper receiving space 116 and a lower receiving space 117 may be formed between the supporting plates 113 and 114. The upper receiving space 116 may be in fluidic communication with an upper opening 116-1. The lower receiving space 117 may be in fluidic communication with a lower opening 117-1. The upper receiving space 116 may have a size configured to receive two AAA dry cells 102 and 104. The lower receiving space 117 may have a size configured to receive one AAA dry cell 106.

The front plate 111 may have a circular plate shape having an outer face 111-1 and an inner face 111-2. Four tubes 111-3 may be formed from the outer face 111-1 of the front plate 111. A thread may be formed on an inner surface of the tubes 111-3. A pair of three front guide rails 111-4, 111-5 and 111-6 corresponding to the three dry cells 102, 104 and 106, respectively, may be formed on the inner face 111-2 of the front plate 111. The front guide rails 111-4 and 111-5 may be extended along upward. In contrast, the front guide rail 111-6 may be extended to downward.

The rear plate 112 may have a circular plate shape having an outer face 112-1 and an inner face 112-2. A receiving groove 112-3 configured to receive the terminal substrate 140 may be formed at the outer face 112-1 of the rear plate 112. A pair of three rear guide rails 112-4, 112-5 and 112-6 corresponding to the three dry cells 102, 104 and 106, respectively, may be formed on the inner face 112-2 of the rear plate 112. The rear guide rails 112-4 and 112-5 may extend along upward. In contrast, the rear guide rail 112-6 may extend to downward.

The central supporting plate 113 may be located at a central portion between the front plate 111 and the rear plate 112. The central supporting plate 113 may have three curved portions configured to make contact with outer surfaces of the dry cells 102, 104 and 106, respectively.

The left supporting plate 114 may include an outer face 114-1, a first inner face 114-2 and a second inner face 114-3. The outer face 114-1 of the left supporting plate 114 may correspond to a portion of the cylindrical body 110 connected between the front plate 111 and the rear plate 112. The first inner face 114-2 of the left supporting plate 114 may have a curved surface configured to make contact with the dry cell 102 in the upper receiving space 116. The second inner face 114-3 of the left supporting plate 114 may have a vertical surface configured to make contact with the dry cell 106 in the lower receiving space 117.

The right supporting plate 115 may include an outer face 115-1, a first inner face 115-2 and a second inner face 115-3. The outer face 115-1 of the right supporting plate 115 may correspond to a portion of the cylindrical body 110 connected between the front plate 111 and the rear plate 112. The first inner face 115-2 of the right supporting plate 115 may have a curved surface configured to make contact with the dry cell 104 in the upper receiving space 116. The second inner face 115-3 of the right supporting plate 115 may have a vertical surface configured to make contact with the dry cell 106 in the lower receiving space 117.

Two slots 118 and 119 may be formed at the outer face 114-1 of the left supporting plate 114 and the outer face 115-1 of the right supporting plate 115. The slots 118 and 119 may be parallel to the vertical surface 114-3 of the left supporting plate 114 and the vertical surface 115-3 of the right supporting plate 115. Further, the slots 118 and 119 may extend to the outer face 111-1 of the front plate 111 and the outer face 112-1 of the rear plate 112.

The resilient member 120 may include a first spring 122, a second spring 124 and a third spring 126. The first spring 122 may include a spring portion 122-1 and a spiral terminal portion 122-2. The spring portion 122-1 may be installed at the front guide rail 111-5. The terminal portion 122-2 may be installed at the front guide rail 111-4. The spring portion 122-1 may make contact with a cathode of the dry cell 104. The terminal portion 122-2 may make contact with an anode of the dry cell 102. The second spring 124 may be installed at the rear guide rail 112-4. The second spring 124 may make contact with a cathode of the dry cell 102. The third spring 126 may be installed at the rear guide rail 112-6. The third spring 126 may make contact with a cathode of the dry cell 106.

The conductive plates 130 may include a first plate 132, a second plate 134 and a third plate 136. The first plate 132 may have a “U” shape. The first plate 132 may have a first end 132-1 arranged on the inner face 112-2 of the rear plate 112 to make contact with the second spring 124. The first plate 132 may have a second end 132-2 opposite to the first end 132-1 arranged on the outer face 112-1 of the rear plate 112. The second end 132-2 of the first plate 132 may be combined with the terminal substrate 140. The second plate 134 may be installed at the rear guide rail 112-5 to make contact with an anode of the dry cell 104. The second plate 134 may have an extension 134-1 extending to the lower receiving space 117. The extension 134-1 of the second plate 134 may make contact with the third spring 126. Thus, the second plate 134 may function as a conductor electrically connected between the anode of the dry cell 104 and the cathode of the dry cell 106. The third plate 136 may be installed at the front guide rail 111-6 to make contact with an anode of the dry cell 106. The third plate 136 may have a “U” shaped extension 136-1. The extension 136-1 of the third plate 136 may extend to the outer face 111-1 of the front plate 111.

The terminal substrate 140 may include a first substrate 142 and a second substrate 144. The first substrate 142 may have four slots assembled with the outer face 111-1 of the front plate 111. The tubes 111-3 may be inserted into the slots 142-1. Three terminal patterns 142-2, 142-3 and 142-4 may be formed on the first substrate 142. Distances between the terminal patterns 142-2, 142-3 and 142-4 and a center point of the first substrate 142 may be different from one another. The terminal pattern 142-3 may be located at a central portion of the first substrate 142. The terminal pattern 142-3 may be soldered to the extension 136-1 of the third plate 136.

The second substrate 144 may have a front face 144-1 and a rear face 144-2. A circular terminal pattern 144-3, a small annular terminal pattern 144-4 and a large annular terminal pattern 144-5 may be formed on the rear face 144-2 of the second substrate 144. The circular terminal pattern 144-3, the small annular terminal pattern 144-4 and the large annular terminal pattern 144-5 may be arranged in a concentric pattern. A long terminal pattern 144-6 and a short terminal pattern 144-7 may be formed on the front face 144-1 of the second substrate 144. The long terminal pattern 144-6 and the short terminal pattern 144-7 may be in radial directions. The long terminal pattern 144-6 may connect the circular terminal pattern 144-3 and the large annular terminal pattern 144-5 to the second end 132-2 of the first plate 132. The short terminal pattern 144-7 may connect the short annular terminal pattern 144-4 to the cable 154. The second substrate 144 may have pinholes 144-8 and 144-9. The pinhole 144-8 may be arranged in a direction substantially the same as an extending direction of the slot 118. The cable 152 may be inserted into the pinhole 144-8. The cable 152 may be soldered to an inner surface of the pinhole 144-8. The pinhole 144-9 may be arranged in a direction substantially the same as an extending direction of the slot 119. The cable 154 may be inserted into the pinhole 144-9. The cable 154 may be soldered to an inner surface of the pinhole 144-9.

The cables 150 may include a first cable 152 and a second cable 154. The first cable 152 may be received in the slot 118. The first cable 152 may be soldered on the terminal pattern 142-2 of the first substrate 142. The second cable 154 may be received in the slot 119. The second cable 154 may be soldered on the terminal pattern 142-4 of the first substrate 142.

The front cap 160 may be assembled with the front plate 111 to form a receiving space. The first substrate 142 and the resilient contact pins 170 may be received in the receiving space. Three pinholes 162, 164 and 166 and four screw holes 168 may be formed through the front cap 160. The pinholes 162, 164 and 166 may correspond to the terminal patterns 142-2, 142-3 and 142-4 of the first substrate 142, respectively. Thus, distances between the pinholes 162, 164 and 166 and a center point of the front cap 160 may be different from one another. The screw holes 168 may correspond to the tubes 111-3, respectively. Thus, the screw holes 168 may be arranged by substantially the same angle with respect to the center point of the front cap 160. Screws 169 may be threaded into the tubes 111-3 through the screw holes 168 to assemble the front cap 160 with the front plate 111.

The resilient contact pin 170 may include pins 171, 172 and 173 and compression springs 174, 175 and 176. Each of the pins 171, 172 and 173 may have flanges 171-1, 172-1 and 173-1. The pins 171, 172 and 173 may have a diameter shorter than that of the pinholes 162, 164 and 166. The flanges 171-1, 172-1 and 173-1 may have a diameter longer than that of the pinholes 162, 164 and 166. The compression springs 174, 175 and 176 may be installed at the flanges 171-1, 172-1 and 173-1 of the pins 171, 172 and 173. Each of the flanges 171-1, 172-1 and 173-1 may have sharp ends protruded through the pinholes 162, 164 and 166. Therefore, the pins 171, 172 and 173 may resiliently make contact with the terminal patterns 142-2, 142-3 and 142-4 of the first substrate 142 by the compression springs 174, 175 and 176.

The dry cell holder 100 may receive the dry cells 102, 104 and 106 to provide three electrical wiring paths including a switching signal path, a positive path and a negative path to a lamp.

The switching signal path may include the pin 171—the compressing spring 174—the terminal pattern 142-2—the first cable 152—the short terminal pattern 144-7—the small annular terminal pattern 144-4. Thus, a switching signal applied between the circular terminal pattern 144-3 and the small annular terminal pattern 144-4 may be transmitted to the lamp through the switching signal path.

The positive path may include the pin 172—the compressing spring 175—the terminal pattern 142-3—the third plate 136—the dry cell 106—the third spring 126, the second plate 134—the dry cell 104—the first spring 122—the dry cell 102—the second spring 124—the first plate 132—the long terminal pattern 144-6—the circular terminal pattern 144-3—the large annular terminal pattern 144-5.

The negative path may include the pin 173—the compression spring 176—the terminal pattern 142-4—the second cable 154—the large annular terminal pattern 144-5.

According to this example embodiment, the dry cell holder may be manufactured by the injection molding using the supporting plates, the front plate and the rear plate, so that the dry cell holder may have a strong strength. Further, although the dry cell holder may be used for a long time, an electrical contact between the dry cell and the terminal may be maintained. Furthermore, the anode and the cathode may be located at the front of the dry cell holder. The switching signal generated at the rear of the dry cell holder may be transmitted to the front of the dry cell holder.

### Flashlight

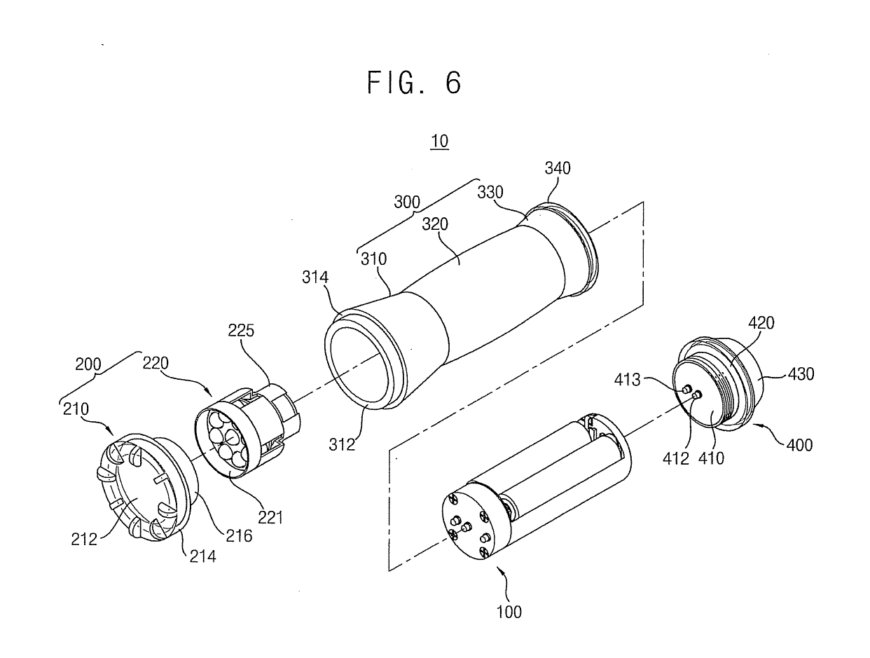

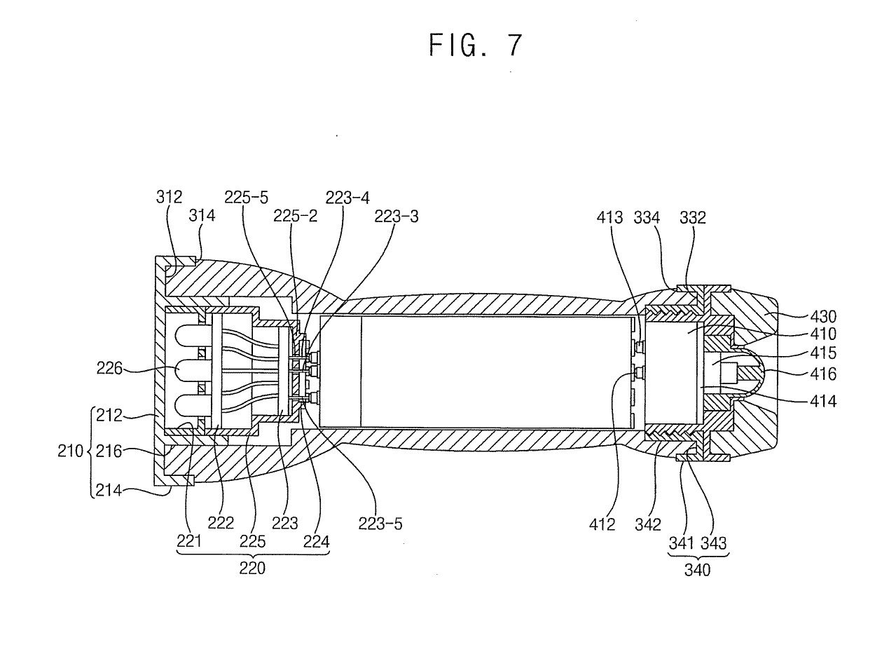

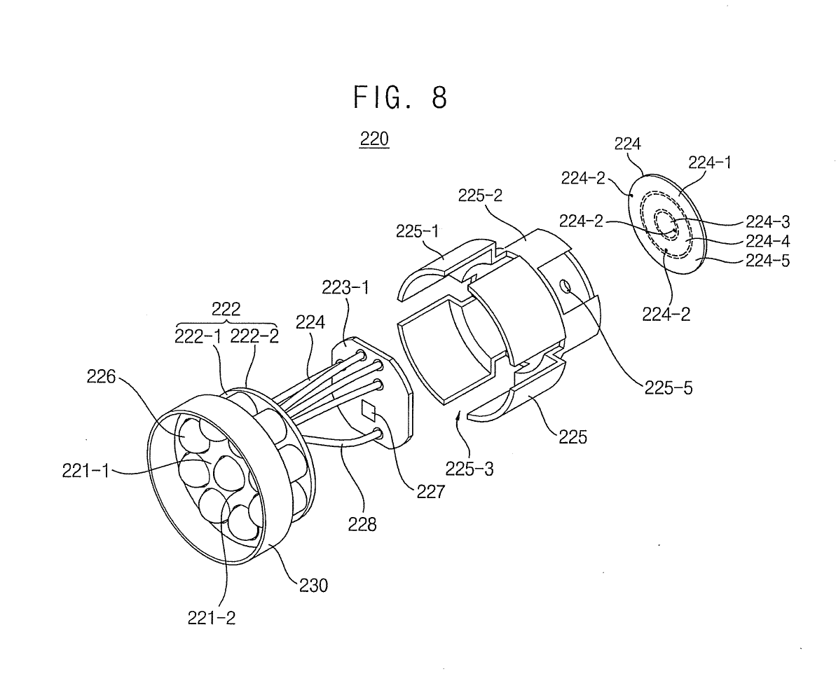

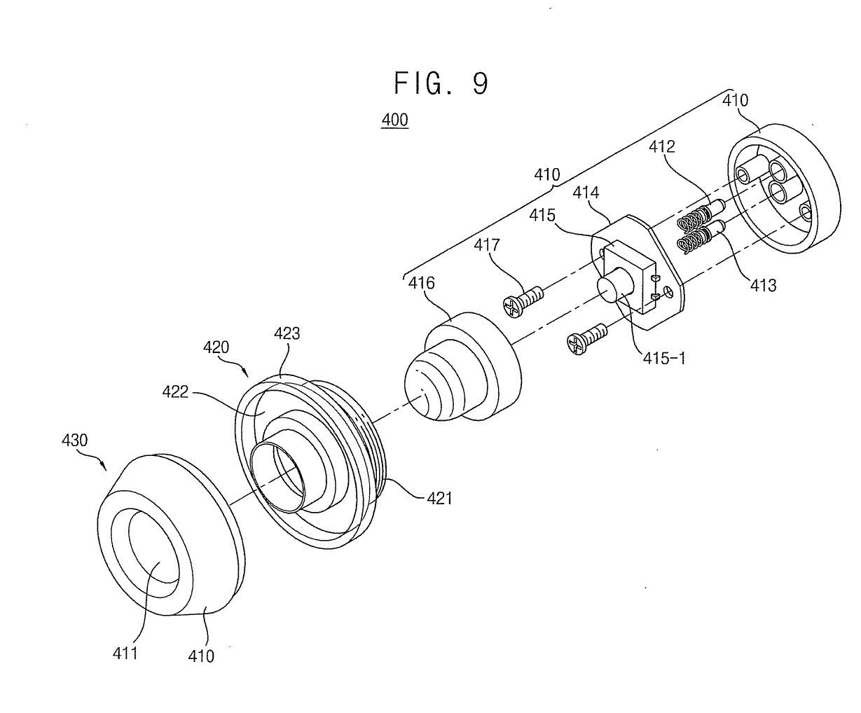

FIG. 6 is an exploded perspective view illustrating a flashlight in accordance with some example embodiments, FIG. 7 is a cross-sectional view illustrating the flashlight in FIG. 6, FIG. 8 is an exploded perspective view illustrating a lamp holder of the flashlight in FIG. 6, and FIG. 9 is an exploded perspective view illustrating a rear cap of the flashlight in FIG. 6.

Referring to FIGS. 6 to 9, a flashlight 10 of this example embodiment may include a head 200, a body 300 and a rear cap 400.

The head 200 may include a transparent cap 210 and a lamp holder 220. The transparent cap 210 may function as a lens.

In some example embodiments, the transparent cap 210 may include a circular plate 212, an outer tube 214 and an inner tube 216. The transparent cap 210 may have one body formed by an injection molding using a transparent resin. The circular plate 212 may have an outer diameter substantially the same as that of a locking jaw 314 of a front portion 310 in the body 300. The outer tube 214 may have a length substantially the same as that between the locking jaw 314 and an end 312 in the front portion 310 of the body 300. The outer tube 214 may have an outer diameter substantially the same as that of the end 312 in the body 300. The inner tube 216 may have an outer diameter substantially the same as an inner diameter of the front portion 310 in the body 300. Thus, the inner tube 216 may be tightly inserted into the front portion 310 of the body 300. A curved portion may be circumferentially formed on an outer surface of the inner tube 216 to strengthen a combination force between an inner surface of the front portion 310 in the body 300 and an outer surface of the inner tube 216. A central portion of the circular plate 212 surrounded by the inner tube 216 may serve as the lens for focusing a light.

The lamp holder 220 may include a reflective mirror 221, a lamp substrate 222, a controlling substrate 223, a terminal substrate 224 and a substrate holder 225.

In some example embodiments, the reflective mirror 221 may have a cuplike shape. A plurality of lamp holes 221-2 may be formed through a bottom surface 221-1 of the reflective mirror 221.

The lamp substrate 222 may have a circular plate shape having a front surface 222-1 and a rear surface 222-2. A plurality of LEDs 226 may be arranged on the front surface 222-1 of the lamp substrate 222. A plurality of electrode patterns may be arranged on the rear surface 222-2 of the lamp substrate 222. The electrode patterns may function as to electrically connect the LEDs 226 by groups. In some example embodiments, the electrode patterns may include a single common cathode pattern and a plurality of input electrode patterns.

The controlling substrate 223 may have a circular plate shape having a front surface 223-1 and a rear surface 223-2. A driving circuit including integrated circuit elements 227 may be arranged on the front surface 223-1. The driving circuit may drive the LEDs 226 by the groups. Electrode patterns for providing electrical signals to the lamp substrate 222 may be arranged on the front surface 223-1 of the controlling substrate 223. The electrode patterns may include a single common cathode electrode pattern and a plurality of output electrode patterns. Three anode pins 223-2, a switching signal electrode pin 223-4 and a cathode pin 223-5 may be arranged on the rear surface 223-2 of the controlling substrate 223.

The terminal substrate 224 may have a circular plate shape having a front surface 224-1 and a rear surface 224-2. Three pinholes may be formed through the front surface 224-1 of the terminal substrate 224. A circular anode terminal pattern 224-3, a small annular terminal pattern 224-4 and a large annular terminal pattern 224-5 may be concentrically arranged on the rear surface 224-2 of the terminal substrate 224. The pinholes may correspond to the three terminal patterns 224-3, 224-4 and 224-5. Thus, distances between the pinholes and a center point of the terminal substrate 224 may be different from one another.

The substrate holder 225 may have a two-stepped cuplike shape having an upper end 225-1 and a lower end 225-2. Holes may be formed through a sidewall of the substrate holder 225. The substrate holder 225 may be formed by an injection molding using plastic. The upper end 225-1 of the substrate holder 225 may have an outer diameter substantially the same as that of the reflective mirror 221. The lower end 225-2 of the substrate holder 225 may have an outer diameter less than a diameter of the reflective mirror 221 and greater than a diameter of the controlling substrate 223. A plurality of holes 225-3 may be alternately formed through the upper end 225-1 and the lower end 225-2 of the substrate holder 225. The lamp substrate 222 may be received in the upper end 225-1 of the substrate holder 225. The controlling substrate 223 may be received in the lower end 225-2 of the substrate holder 225. A receiving groove 225-2 configured to receive the terminal substrate 224 may be formed at an outer bottom surface 225-4 of the substrate holder 225. At least three holes 225-5 may be formed through the bottom surface 225-4 of the substrate holder 225. The anode pins 223-3, the switching signal electrode pin 223-4 and the cathode pin 223-5 of the controlling substrate 223 may be inserted into the pinholes of the terminal substrate 224 through the holes 224-2. The lamp substrate 222 in the upper end 225-1 of the substrate holder 225 and the controlling substrate 223 in the lower end 225-2 of the substrate holder 225 may be electrically connected with each other via a plurality of cables 228. The cables 228 may be received in the substrate holder 225.

Therefore, the lamp holder 220 may have a receiving space between the reflective mirror 221 and the substrate holder 225 configured to receive the lamp substrate 222, the cables 228 and the controlling substrate 223. The terminal substrate 224 may be exposed through the rear surface 220-2 of the lamp holder 220.

The body 300 may include a front portion 310, a central portion 320 a rear portion 330. In some example embodiments, the body 300 may include a wooden tubular shape.

The front portion 310 and the rear portion 330 may have a funnel like shape having a gradually increasing diameter from the central portion 320. The central portion 320 may be configured to receive the cylindrical dry cell holder 100. The head 200 may be combined with the front portion 310. The rear cap 400 may be threadedly combined with the rear portion 330. The central portion 320 may have an inner diameter slightly greater than a diameter of the dry cell holder 100. In some example embodiments, the wooden body 300 may function as to lighten a weight of the flashlight 10. Further, when a user may grip the wooden body 300, the user may feel warmer contact compared to a metal body. The central portion 320 may have a convex shape having a gradually decreased diameter toward the front portion 310 and the rear portion 330. Locking jaws 314 and 334 may be formed at an end 312 of the front portion 310 and an end 332 of the rear portion 330.

A nut portion 340 may be formed at the rear portion 330. In some example embodiments, the nut portion 340 may include a transparent resin. The nut portion 340 may include an inner tube 341, an outer tube 342 and an annular plate 343. Ends of the inner tube 341 and the outer tube 342 may be integrally combined with an edge and an outer edge of the annular plate 343, respectively. An end of the rear portion 330 may be tightly inserted into between the inner tube 341 and the outer tube 342. A threaded portion may be formed at an inner surface of the inner tube 341.

The rear cap 400 may include a switching portion 410, a bolt portion 420 and a ring 430. In some example embodiments, the bolt portion 420 may include a transparent resin. The ring 430 may include a wood.

The switching portion 410 may include a cap 411, resilient contact pins 412 and 413, a substrate 414, a toggle switch 415 and a rubber cap 416. The cap 411 may be combined with the substrate 414 using screws 417 to form a receiving space. The resilient contact pins 412 and 413 may be received in the receiving space. The resilient contact pins 412 and 413 may have sharp ends protruded from the cap 411. The protruded sharp ends of the resilient contact pins 412 may be resiliently moved in front and rear directions. The toggle switch 415 may be installed at the substrate 414. The toggle switch 415 may have a button 415-1 covered with the rubber cap 416. When the button 415-1 of the toggle switch 415 in the switching portion 410 is pressed, the switching portion 410 may be turned-on, so that the inner ends of the resilient contact pins 412 and 413 may be electrically connected with each other. When the button 415-1 of the toggle switch 415 in the switching portion 410 is pressed again, the switching portion 410 may be turned-off, so that the inner ends of the resilient contact pins 412 and 413 may be electrically isolated with each other. The resilient contact pin 412 may make contact with the circular terminal pattern on the rear plate of the dry cell holder 100. The resilient contact pin 413 may make contact with the small annular terminal pattern on the rear plate of the dry cell holder 100.

The bolt portion 420 may include an inner tube 421, a flange 422 and an outer tube 423. The flange 422 may be integrally formed with a central outer surface of the inner tube 421. The outer tube 423 may be integrally combined with an edge of the flange 422. A threaded portion may be formed on an outer surface of the inner tube 421 at a front of the flange 422. The threaded portion may be threadedly combined with the nut portion 340. The wooden ring 430 may be tightly inserted into between the inner tube 421 and the outer tube 423 at a rear of the flange 422. The rubber cap 416 may have an end inserted into the inner tube 421. Thus, the end of the rubber cap 416 may be protruded from the wooden ring 430 through the bolt portion 420. As a result, when the rubber cap 416 may be pressed, the button 415-1 of the toggle switch 415 may be operated.

FIG. 10 is a circuit diagram illustrating the flashlight in FIG. 6.

Referring to FIG. 10, the nine LEDs 226 may be arranged on the lamp substrate 222. The LEDs 226 may be connected in parallel with each other. The LEDs 226 may have a common cathode line connected to the cathode. The integrated circuit chip 227 on the controlling substrate 223 may receive a power from the dry cell in the dry cell holder 100 and a switching signal of the toggle switch 415. The integrated circuit chip 227 may generate first and second control signals C1 and C2 in accordance with the changes of the switching signals. Here, the first signal C1 may include an “on” signal. The second signal C2 may include an “on/off” signal. A collector of a transistor Q1 may be connected to the anode through a resistance R1. An emitter may be connected to a common anode line of the LEDs 226. The first signal C1 may be applied to a base of the transistor Q1 through a resistance R3. Thus, during applying the first signal C1 through the transistor Q1, the LEDs 226 may be maintained at the “on” state. In contrast, when the first signal C1 is cut off, the LEDs 226 may be converted into the “off” state. A collector of the transistor Q2 may be connected to an anode through a resistance R2. An emitter may be connected to the common anode line of the LEDs 226. The second signal C2 may be applied to the base of the transistor Q1 through a resistance R4. Thus, during applying the second signal C2 through the transistor Q2, the LEDs 226 may be maintained at the “on/off” state. In contrast, when the second signal C2 is cut off, the LEDs 226 may be turned-off.

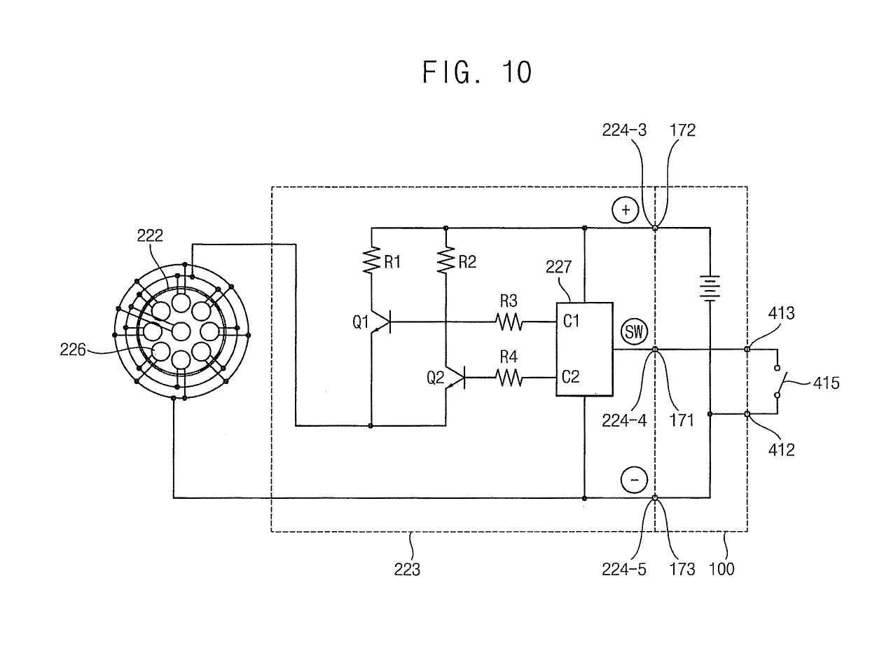

FIG. 11 is a cross-sectional view illustrating a flashlight in accordance with some example embodiments.

Here, a flashlight of this example embodiment may include elements substantially the same as those of the flashlight 10 in FIG. 6 except for a body. Thus, any further illustrations with respect to the same elements may be omitted herein for brevity.

Referring to FIG. 11, the flashlight 20 of this example embodiment may include a head 21, a body 22 and a rear cap 23.

The head 21 may include a lens holding tube 230 and a lamp holding tube 240. An O-ring 232 and a transparent lens 233 may be installed at an inner locking jaw 231 of the lens holding tube 230. A bolt portion 234 may be formed on a rear outer surface of the lens holding tube 230. A nut portion 241 may be formed on a front inner surface of the lamp holding tube 240. A nut portion 242 may be formed on a rear outer surface of the lamp holding tube 240. The bolt portion 234 of the lens holding tube 230 may be screwed to the nut portion 242 of the lamp holding tube 240.

The body 22 may be configured to receive the dry cell holder 100. A bolt portion 22-1 may be formed on a front outer surface of the body 22. A nut portion 22-2 may be formed on a rear outer surface of the body 22. The bolt portion 22-1 may be screwed to the nut portion 242 of the lamp holding tube 240.

The rear cap 23 may include a switching portion 410, a bolt portion 420 and a ring 430. The switching portion 410 may be substantially the same as the switching portion of the flashlight 10 in FIG. 6. However, the bolt portion 420 and the ring 430 may include a single metal tube. A bolt portion 23-1 may be formed on a front outer surface of the metal tube. The bolt portion 23-1 may be screwed to the nut portion 22-2 of the body 22.

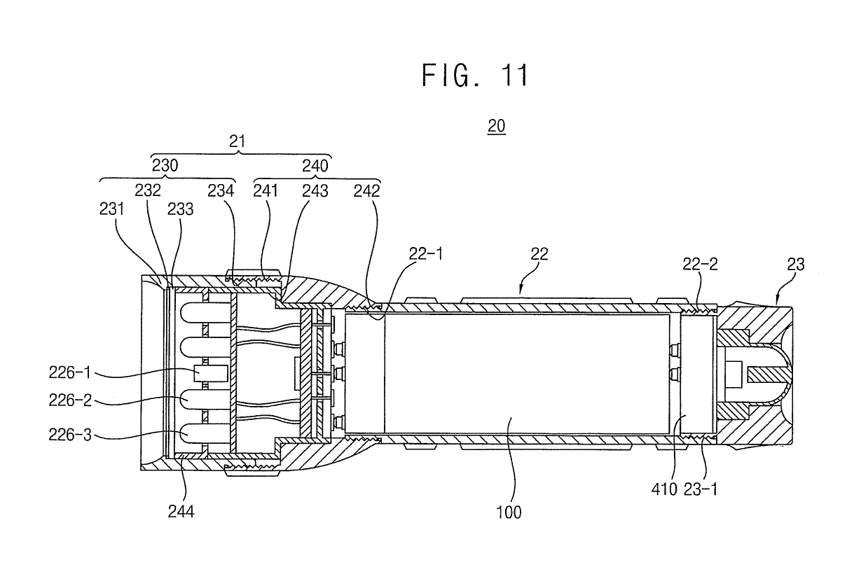

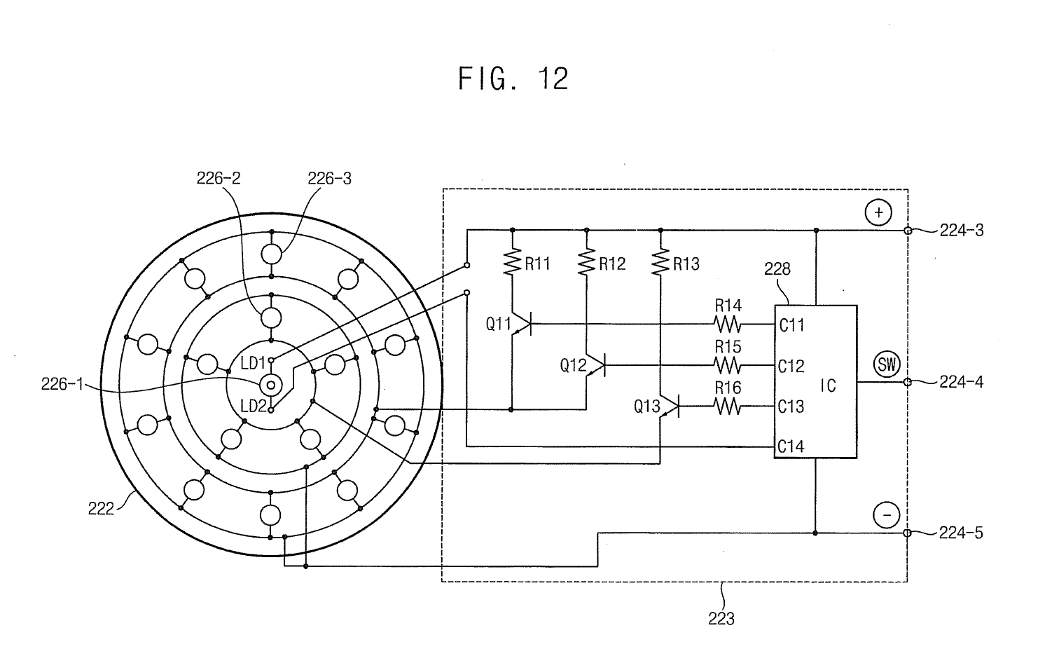

FIG. 12 is a circuit diagram illustrating the flashlight in FIG. 11.

Referring to FIG. 12, holes for installing laser diodes 226-1 for a point may be formed through a central portion of a reflective mirror 244. Five color emitting diodes 226-2 may be concentrically arranged around the holes. Ten white emitting diodes 226-3 may be concentrically arranged at an edge portion of the reflective mirror 244.

A lamp substrate 222 inserted into a lamp holder 243 may include the laser diode 226-1, a signal LED group 226-2 and an illumination LED group 226-3.

The signal LED group 226-2 and the illumination LED group 226-3 may be connected in parallel with each other. A common cathode line of the emitting diodes may be connected to a cathode. An integrated circuit chip 228 may receive a power from the dry cell holder 100 through a circular conductive pattern 224-3 and a large annular conductive pattern 224-5 and a switching signal from a toggle switch 415 through a small annular conductive pattern 224-4. The integrated circuit chip 228 may generate first, second, third and fourth control signals C11, C12, C13 and C14 in accordance with the changes of the switching signals. Here, the first signal C11 may include an “on” signal. The second signal C12 may include an “on/off” signal. The third signal C13 may include a color-on signal. The fourth signal C14 may include a pointer-on signal. A collector of a transistor Q11 may be connected to the anode through a resistance R11. An emitter may be connected to a common anode line of the LEDs 226-3. The first signal C11 may be applied to a base of the transistor Q11 through a resistance R14. Thus, during applying the first signal C11 through the transistor Q11, the LEDs 226-3 may be maintained in the “on” state. In contrast, when the first signal C11 is cut off, the LEDs 226-3 may be converted into the “off” state.

A collector of the transistor Q12 may be connected to the anode through a resistance R12. An emitter may be connected to the common anode line of the LEDs 226-3. The second signal C12 may be applied to a base of the transistor Q12 through a resistance R15. Thus, during applying the second signal C12 through the transistor Q12, the LEDs 226-3 may be maintained in the “on/off” state. In contrast, when the second signal C2 is cut off, the LEDs 226-3 may be turned-off.

A collector of the transistor Q13 may be connected to the anode through a resistance R13. An emitter may be connected to a common anode line of the LEDs 226-2. The third signal C13 may be applied to a base of the transistor Q13 through a resistance R16.

Thus, during applying the third signal C13 through the transistor Q13, the LEDs 226-2 may be maintained in the color-on state. In contrast, when the third signal C3 is cut off, the LEDs 226-2 may be turned-off.

An anode of the laser diode 226-1 may be connected to the anode. The fourth signal C14 may be applied to the anode of the laser diode 226-1. Thus, the laser diode 226-1 may function as the point only when the fourth signal C14 may be applied to the laser diode 226-1.

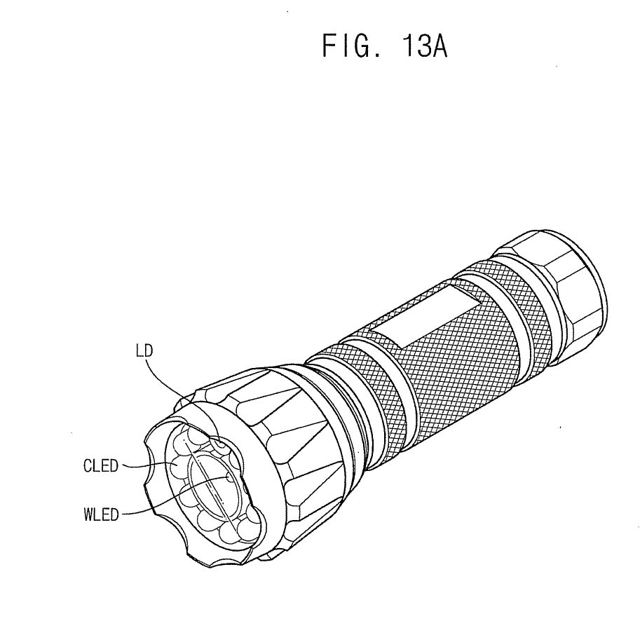

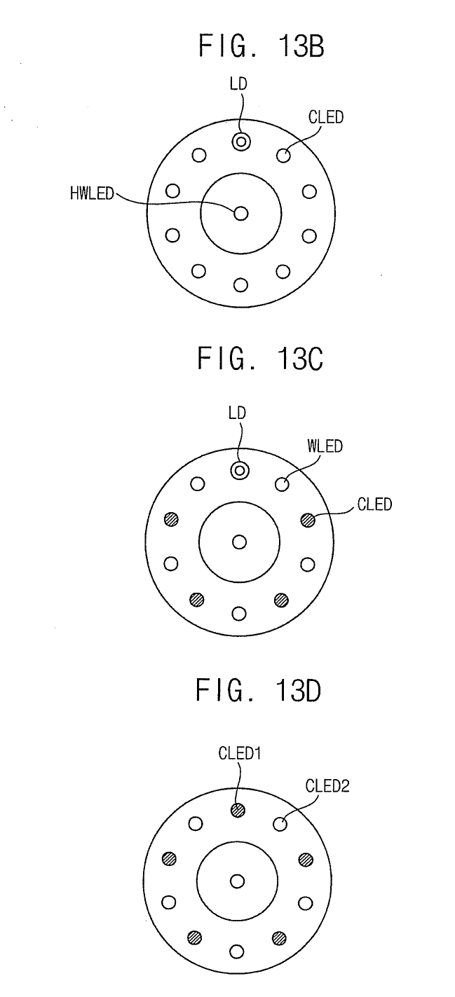

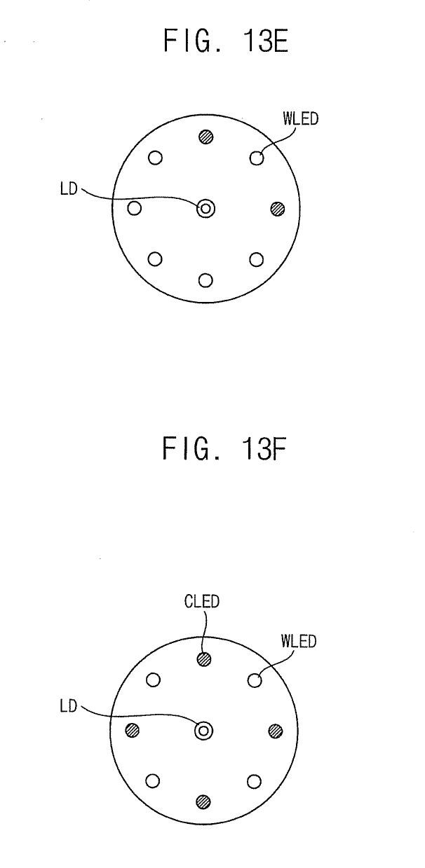

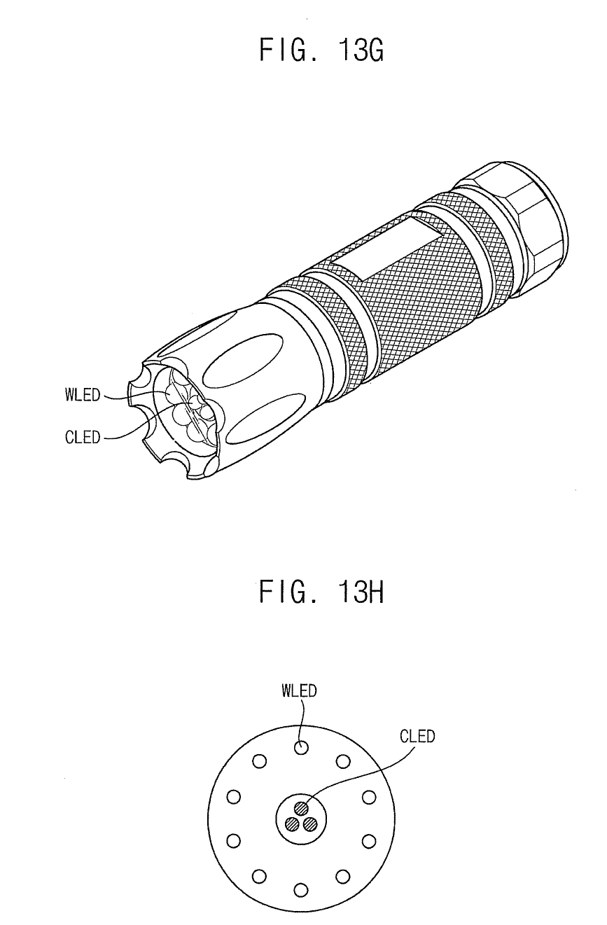

FIG. 13A is a perspective view illustrating a flashlight in accordance with some example embodiments, FIG. 13B is a front view illustrating a lamp arrangement of the flashlight in FIG. 13A, FIGS. 13C to 13F are front views illustrating a lamp arrangement of a flashlight in accordance with some example embodiments.

Referring to FIGS. 13A and 13B, a lamp of a flashlight in accordance with this example embodiment may include a white LED HWLED, ten color LEDs CLED and a pointer laser diode LD. The white LED HWLED may be arranged at a central portion of the lamp. The color LEDs and the pointer laser diode LD may be arranged around the white LED HWLED. A drive sequence may be turn-on of the HWLED, turn-on of the CLED, turn-off of the CLED and turn-on of the LD.

Referring to FIG. 13C, a lamp of a flashlight in accordance with this example embodiment may include a central white LED HWLED, five color LEDs CLED, five white LEDs WLED and a pointer laser diode LD. The five color LEDs CLED and the five whit LEDs WLED may be alternately arranged. A drive sequence may be turn-on of the HWLED, turn-on of the WLED, turn-off of the WLED, turn-on of the CLED and a turn-on of the LD.

Referring to FIG. 13D, a lamp of a flashlight in accordance with this example embodiment may include a central white LED HWLED, six color LEDs CLED1 and CLED2 and five white LEDs WLED. The six color LEDs CLED1 and CLED2 and the five whit LEDs WLED may be alternately arranged. A drive sequence may be turn-on of the HWLED, turn-on of the CLED1, turn-on of CLED2 and turn-off of the CLED1.

Referring to FIG. 13E, a lamp of a flashlight in accordance with this example embodiment may include a pointer laser diode LD and eight white LEDs WLED. A drive sequence may be turn-on of the WLED, turn-off of the WLED and turn-on of the LD.

Referring to FIG. 13F, a lamp of a flashlight in accordance with this example embodiment may include a pointer laser diode LD, four white LEDs WLED and four color LEDs CLED. The white LEDs WLED and the color LEDs CLED may be alternately arranged. A drive sequence may be turn-on of the WLED, turn-on of the CLED, turn-off of the WLED and turn-on of the LD.

FIG. 13G is a perspective view illustrating a flashlight in accordance with some example embodiments, and FIG. 13H is a front view illustrating a lamp arrangement of the flashlight in FIG. 13G.

Referring to FIGS. 13G and 13H, a lamp of a flashlight in accordance with this example embodiment may include three color LEDs CLED and eight white LEDs WLED. The color LEDs CLED may be arranged at a central portion of the lamp. The white LEDs WLED may be arranged around the color LEDs CLE. A drive sequence may be turn-on of the WLED, turn-on of the CLED and turn-off of the WLED.

In some example embodiments, other lamp arrangements may be employed as well as the above-illustrated arrangements. Further, the color LEDs may include various colors such as yellow, red, green, blue, etc.

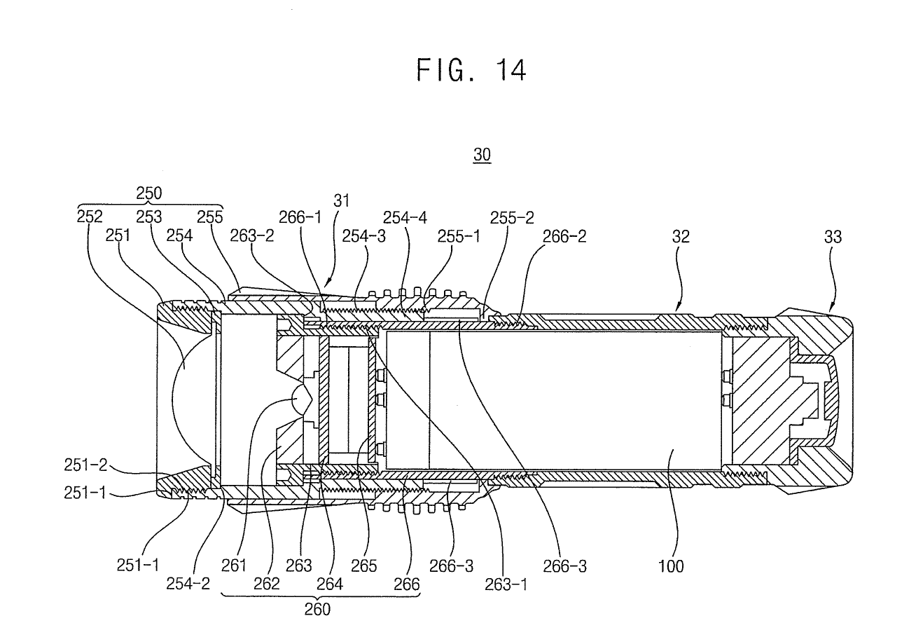

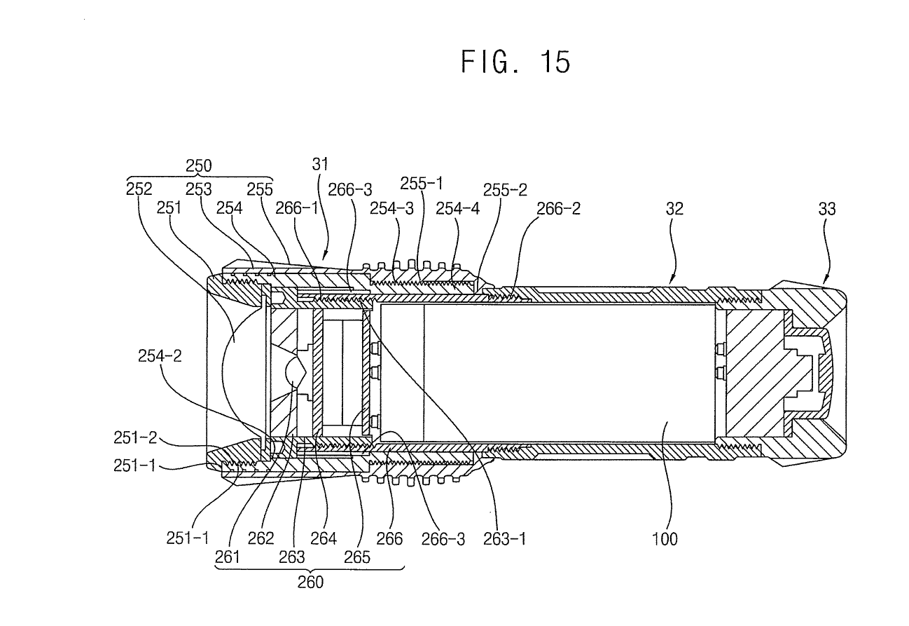

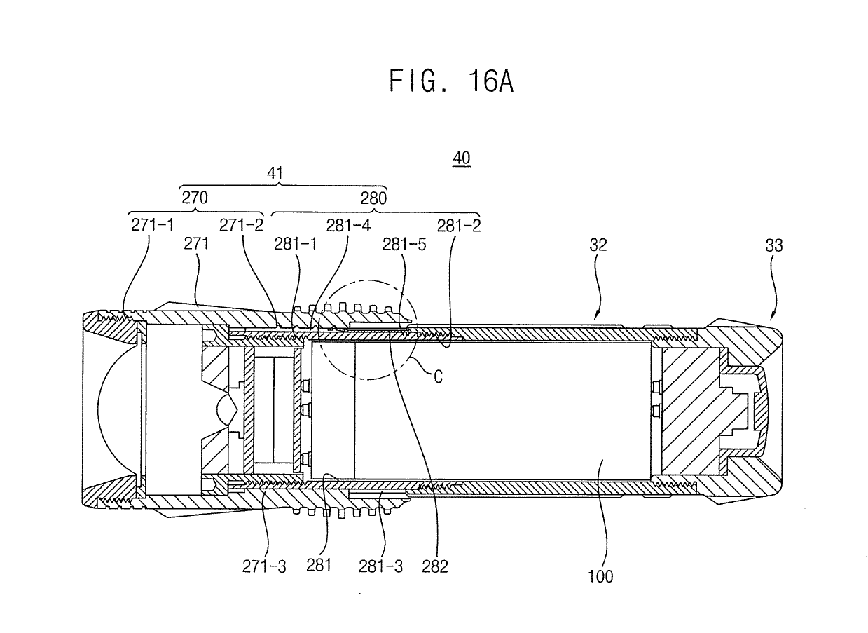

FIG. 14 is a cross-sectional view illustrating a flashlight focusing a light in accordance with some example embodiments, and FIG. 15 is a cross-sectional view illustrating the flashlight in FIG. 14 diffusing a light.

Referring to FIGS. 14 and 15, a flashlight 30 of this example embodiment may include a head 31, a body 32 and a rear cap 33.

The head 31 may include a lens holding portion 250 and a lamp holding portion 360.

The lens holding portion 250 may include a lens fixing tube 251, a convex lens 252, a lens holding ring 253, a lens holding tube 254 and a rotating tube 255.

A flange 251-1 may be formed at a front end of the lens fixing tube 251. A bolt portion 251-2 may be formed on a rear outer surface of the lens fixing tube 251.

A nut portion 254-1 may be formed on a front inner surface of the lens holding tube 254. A locking jaw 254-2 may be formed on an inner surface of the nut portion 254-1. The lens holding ring 253 may be installed on the locking jaw 254-2. The convex lens 252 may be installed in the lens holding ring 253. The bolt portion 251-2 of the lens fixing tube 251 may be screwed to the nut portion 254-1 of the lens holding tube 254 to fix the convex lens 251 to the lens fixing tube 251. A bolt portion 254-3 may be formed on a rear outer surface of the lens holding tube 254. A guide rail 254-4 may extend in the lens holding tube 254.

A nut portion 255-1 may be formed on an inner surface of the rotating tube 255. A locking ring 255-2 may be formed on a rear inner surface of the rotating tube 255. The bolt portion 254-3 of the lens holding tube 254 may be screwed to the nut portion 255-1 of the rotating tube 255.

The lamp holding tube 260 may include LEDs 261, a cover ring 262, a lamp holding tube 263, a lamp substrate 264, a terminal substrate 265 and a connecting tube 266.

The LEDs 261 may be installed on the lamp substrate 264. The LEDs 261 may be received in the lamp holding tube 263. The cover ring 262 may be combined with the lamp holding tube 263 to cover lamp holding tube 262 except for the LEDs 261.

A locking jaw 263-1 may be formed on a front outer surface of the lamp holding tube 263. A bolt portion 263-2 may be formed on a rear outer surface of the lamp holding tube 263. The terminal substrate 265 may be received in rear inner space of the lamp holding tube 263. A driving circuit of the LEDs 261 may be mounted on a front surface of the terminal substrate 265. A conductive pattern, which may be substantially the same as the terminal substrate 224 in FIG. 6, may be formed on a rear surface of the terminal substrate 265.

A nut portion 266-1 may be formed on a front inner surface of the connecting tube 266. A bolt portion 266-2 may be formed on a rear outer surface of the connecting tube 266. A guide groove 266-3 may be formed at the outer surface of the connecting tube 266. The bolt portion 263-2 of the lamp holding tube 263 may be screwed to the nut portion 266-1 of the connecting tube 266. The guide rail 254-4 of the lamp holding tube 254 may be slidably inserted into the guide groove 266-3 of the connecting tube.

A nut portion 32-1 may be formed on a front inner surface of the body 32. The bolt portion 266-2 of the connecting tube 266 may be screwed to the nut portion 32-1 of the body 32.

Thus, the locking ring 255-2 of the rotating tube 255 may rotate between the front of the body 32 and the locking jaw 254-2 of the lens holding tube 254 in the guide groove 266-3 of the connecting tube 266. In contrast, the locking ring 255-2 of the rotating tube 255 may not move along forward and backward directions.

When the rotating tube 255 rotates, the guide rail 254-4 of the lens holding tube 254 may not rotate due to the guide groove 266-3 of the connecting tube 266, so that the guide rail 254-4 may linearly move. When the rotating tube 255 rotates clockwise with the body 32 being fixed, the lens holding tube 254 may move backwardly. In contrast, when the rotating tube 255 may be counterclockwisely rotated, the lens holding tube 254 may be forwardly moved. When the guide rail 254-4 may be blocked by the locking jaw 263-1, the guide rail 254-4 may be stopped.

As shown in FIG. 13, when the lens 252 moves forward, a focal length between the convex lens 252 and the LEDs 261 may be lengthened. Thus, a point light source, which may be emitted at a focal point of the convex lens 252, may emit a parallel light through the convex lens 252, so that the parallel light may be focused to illuminate a distant small area.

In contrast, as shown in FIG. 14, when the lens 252 moves backward, the focal length between the convex lens 252 and the LEDs 261 may be shortened. Thus, a light emitted from the point light source may diffuse to illuminate a large area.

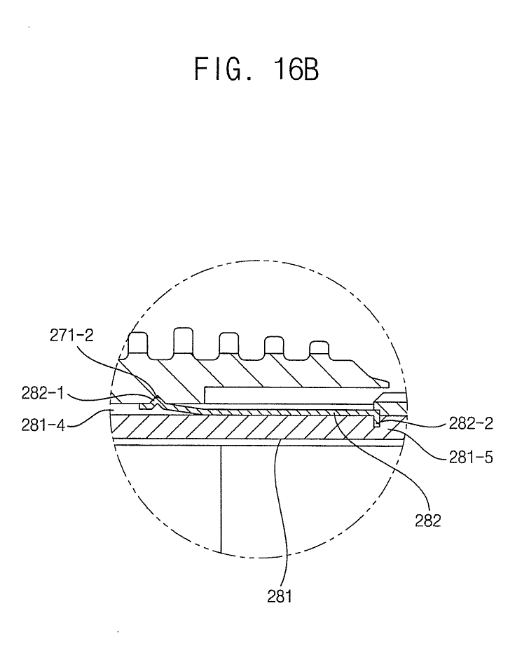

FIG. 16A is a cross-sectional view illustrating a flashlight focusing a light in accordance with some example embodiments, and FIG. 16B is an enlarged cross-sectional view illustrating a portion “C” in FIG. 16A.

Here, a flashlight of this example embodiment may include elements substantially the same as those of the flashlight 30 in FIG. 14 except for a head. Thus, the same reference numerals refer to the same elements and any further illustrations with respect to the same elements are omitted herein for brevity.

Referring to FIGS. 16A and 16B, the flashlight 40 of this example embodiment may include a head 41, a body 32 and a rear cap 33.

The head 41 may include a lens holding portion 270 and a lamp holding portion 280.

The lens holding portion 270 may include a lens holding tube 271. A nut portion 271-1 may be formed on a front inner surface of the lens holding tube 271. A locking groove 271-2 may be formed at a rear inner surface of the lens holding tube 271. A guide rail 271-3 may be formed on a rear inner surface of the lens holding tube 271 opposite to the locking groove 271-2.

The lamp holding portion 280 may include a connecting tube 281 and a resilient plate 282. A nut portion 281-1 may be formed on a front inner surface of the connecting tube 281. A bolt portion 281-2 may be formed on a rear outer surface of the connecting tube 281. A lower guide groove 281-3 and an upper guide groove 281-4 may be formed on an outer surface of the connecting tube 281. A fixing groove 281-5 may be formed at a rear outer surface of the upper guide groove 281-4. The bolt portion 263-1 of the lamp holding tube 263 may be screwed to the nut portion 281-1 of the connecting tube 281. The guide rail 271-3 of the lamp holding tube 271 may be meshed with the lower guide groove 281-3 of the connecting tube 281. A protrusion 282-1 of the resilient plate 282 may be inserted into the upper guide groove 281-4 of the connecting tube 281. A bent portion 282-2 of the resilient plate 282 may be fixed to the fixing groove 281-5 of the connecting tube 281.

Therefore, the guide rail 271-3 of the lens holding tube 271 may slidably move forward and backward along the lower guide rail 271-3. Here, when the protrusion 282-1 of the resilient plate 282 makes contact with the locking groove 271-2, a sound may be generated between the protrusion 282-1 and the locking groove 271-2. Thus, a user may adjust a focal length of the lens based on the sound.

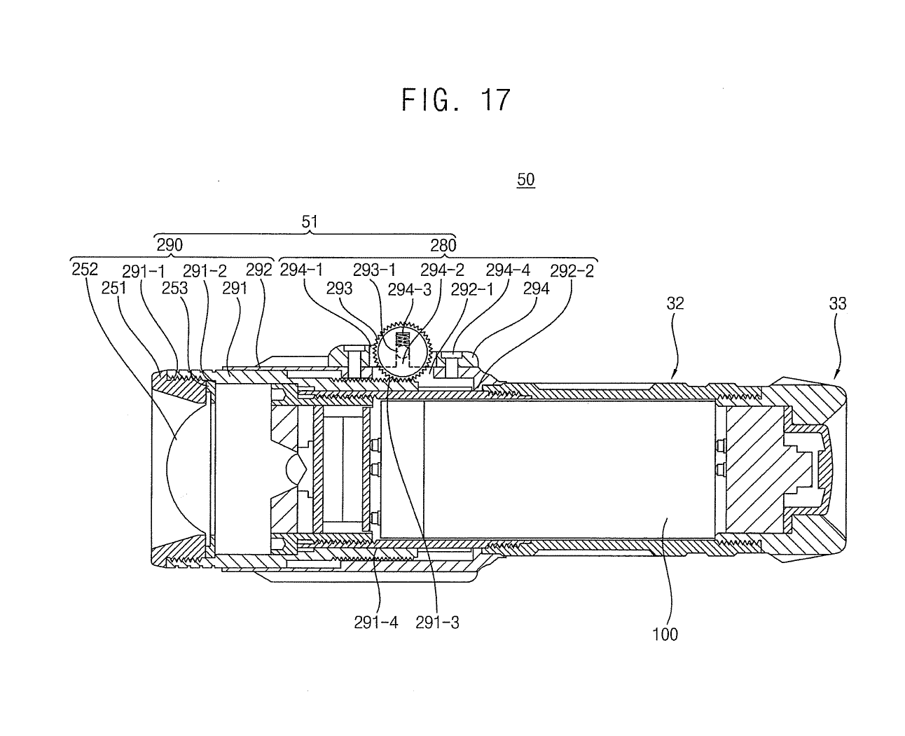

FIG. 17 is a cross-sectional view illustrating a flashlight focusing a light in accordance with some example embodiments.

Here, a flashlight of this example embodiment may include elements substantially the same as those of the flashlight 30 in FIG. 14 except for a head. Thus, the same reference numerals refer to the same elements and any further illustrations with respect to the same elements are omitted herein for brevity.

Referring to FIG. 17, the flashlight 50 of this example embodiment may include a head 51, a body 32 and a rear cap 33.

The head 51 may include a lens holding portion 290 and a lamp holding portion 260. The lens holding portion 290 may include a lens holding tube 291, a pinion fixing tube 292, a pinion 293 and a pinion supporting portion 294.

A nut portion 291-1 may be formed on a front inner surface of the lens holding tube 291. A locking jaw 291-2 may be formed on an inner surface of the nut portion 291-1. The lens holding ring 253 may be installed at the locking jaw 291-2. The convex lens 252 may be installed at the lens holding ring 253. The bolt portion 251-2 of the lens fixing tube 251 may be screwed to the nut portion 291-1 of the lens holding tube 291 to fix the convex lens 252 to the lens fixing tube 251. A rack 291-3 may be formed on a rear outer surface of the lens holding tube 291. A guide rail 291-4 may be formed on an inner surface of the lens holding tube 291.

The pinion fixing tube 292 may include a hole 292-1 and a locking ring 292-2. The hole 292-1 may be formed through an end of the pinion fixing tube 292. The locking ring 292-2 may be formed on a rear inner surface of the pinion fixing tube 292.

The pinion supporting portion 294 may have a hole 294-1, an axial groove 294-2 and a compression spring 294-3. The hole 294-1 of the pinion supporting portion 294 may be configured to receive the pinion 293. The axial groove 294-2 of the pinion supporting portion 294 may be configured to receive a shaft 293-1 of the pinion 293. The compression spring 294-3 may compress downwardly the pinion shaft 293-1. The hole 294-1 of the pinion supporting portion 294 may be in fluidic communication with a hole 292-1 of the pinion fixing tube 292. An upper outer surface of the pinion 293 may be slightly protruded from an upper surface of the pinion supporting portion 294. A lower outer surface of the pinion 293 may be meshed with the rack 291-3 of the lens holding tube 291 exposed through the hole 292-1 of the pinion fixing tube 292.

Therefore, when the pinion 293 rotates, the pinion 293 may also rotate with respect to the pinion shaft 293-1, so that the rack 291-3 may move forward and backward. As a result, a light may be focused by forwardly and downwardly moving the convex lens 252.

According to some example embodiments, a rear switching signal may be transmitted to the head through the dry cell holder, so that the flashlight may have various displays and high quality. Further, because a current path through the body may not be required, the body may include a nonconductor such as wood, plastic, etc., so that the flashlight may have a light weight and good appearance. Furthermore, the dry cell holder may have one body including the front plate, the rear plate and the supporting plate by the injection molding, so that the dry cell holder may have improved durability.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A dry cell holder comprising:
a cylindrical body having a front plate and a rear plate to receive three dry cells;
an anode terminal formed on an outer surface of the front plate;
a cathode terminal formed on the outer surface of the front plate;
a switching signal terminal formed on the outer surface of the front plate;
a first electrode terminal formed on an outer surface of the rear plate, the first electrode terminal being electrically connected to the anode terminal to serially connect the three dry cells from one another, and the first electrode terminal being electrically connected to the cathode terminal;
a second electrode terminal formed on the outer surface of the rear plate, the second electrode terminal being electrically connected to the switching signal terminal for allowing switching signals to be transmitted to a front of the cylindrical body, the switching signals being generated between the first electrode terminal and the second electrode terminal.

2. The dry cell holder of claim 1, wherein the cylindrical body is received in a flashlight.

3. A dry cell holder comprising:
a front plate;
a rear plate; and
a supporting plate connected between the front plate and the rear plate, the supporting plate being integrally formed with the front plate and the rear plate to form a cylindrical body,
wherein the cylindrical body has a first receiving space configured to receive two dry cells along a first direction, and a second receiving space configured to receive one dry cell along a second direction substantially opposite to the first direction, the first receiving space is in fluidic communication with a first opening formed through a first outer surface of the cylindrical body, and the second receiving space is in fluidic communication with a second opening formed through a second outer surface of the cylindrical body opposite to the first outer surface.

4. The dry cell holder of claim 3, wherein the supporting plate comprises:
a central support arranged between the front plate and the rear plate, the central support having three curved portions being configured to make contact with side surfaces of the dry cells;
a first side support arranged at one side between the first opening and the second opening, the first side support having an outer surface, an inner surface and a vertical surface, the outer surface being configured to form a portion of the cylindrical body connected between the front plate and the rear plate, the inner surface being configured to form a curved portion making contact with any one of the two dry cells in the first receiving space, and the vertical surface being configured to make contact with the dry cell in the second receiving space; and
a second side support arranged at another side between the first opening and the second opening, the second side support having an outer surface, an inner surface and a vertical surface, the outer surface being configured to form a portion of the cylindrical body connected between the front plate and the rear plate, the inner surface being configured to form a curved portion making contact with any one of the two dry cells in the first receiving space, and the vertical surface being configured to make contact with the dry cell in the second receiving space.

5. The dry cell holder of claim 4, wherein each of the first and the second side supports has a groove formed from a portion of the side support adjacent to the second opening of the outer surface in the side support to the outer surfaces of the front plate and the rear plate along a direction substantially parallel to the vertical surface to receive a cable extending from the rear plate to the front plate.

6. A dry cell holder comprising:
a cylindrical body having a first receiving space configured to receive two dry cells and being in fluidic communication with a first opening formed through a first outer surface of the cylindrical body, a second receiving space configured to receive one dry cell along a second direction substantially opposite to the first direction and being in fluidic communication with a second opening formed through a second outer surface of the cylindrical body opposite to the first outer surface, and first and second grooves formed at both sides of the second receiving space;
a front terminal cap assembled with a front of the cylindrical body, the front terminal cap including a plurality of resilient contact pins that have different radii from a center point of the front terminal cap to provide a front of the cylindrical body with a first electrode, a second electrode and a third electrode;
a rear terminal plate assembled with a rear of the cylindrical body to provide a rear of the cylindrical body with concentrically arranged first and second electrodes; and
first and second cables received in the first and second grooves, respectively, to electrically connect the first and second electrodes of the rear terminal plate with the first and second electrodes of the front terminal cap.

7. A dry cell holder comprising:
a cylindrical body having a first receiving space configured to receive first and second AAA dry cells and being in fluidic communication with a first opening formed through a first outer surface of the cylindrical body, a second receiving space configured to receive a third AAA dry cell along a second direction substantially opposite to the first direction and being in fluidic communication with a second opening formed through a second outer surface of the cylindrical body opposite to the first outer surface, and first and second grooves formed at both sides of the second receiving space;
a first resilient conductive member installed at an inner surface of a front plate in the cylindrical body configured to form the first receiving space, the first resilient conductive member having one end configured to resiliently make contact with a cathode of the first AAA dry cell in the first receiving space and another end configured to resiliently make contact with an anode of the second AAA dry cell in the first receiving space;
a first conductive plate installed at an inner surface of the front plate in the cylindrical body configured to form the second receiving space, the first conductive plate having one end configured to make contact with an anode of the third AAA dry cell and another end extending to an outside of the cylindrical body;
a second conductive plate installed at an inner surface of a rear plate in the cylindrical body configured to form the first receiving space, the second conductive plate having one end configured to make contact with an anode of the first AAA dry cell and another end extending to the inner surface of the rear plate;
a second resilient conductive member installed at an inner surface of the rear plate in the cylindrical body configured to form the second receiving space, the second resilient conductive member having one end configured to make contact with another end of the second conductive plate and another end configured to resiliently make contact with a cathode of the third AAA dry cell in the second receiving space;
a third resilient conductive member installed at an inner surface of the rear plate in the cylindrical body configured to form the first receiving space, the third resilient conductive member having one end configured to resiliently make contact with a cathode of the second AAA dry cell in the first receiving space and another end extending to the outside of the cylindrical body;
a front circuit substrate configured to make contact with the front plate of the cylindrical body, a central conductive pattern, a large conductive pattern and a small conductive pattern having different radii from a center point of the front circuit substrate being formed on a front surface of the front circuit substrate, and the central conductive pattern being electrically connected to another end of the first conductive plate;
a rear circular circuit substrate configured to make contact with the rear plate of the cylindrical body, a central conductive pattern, a large annular conductive pattern and a small annular conductive pattern being concentrically arranged on a rear surface of the rear circular circuit substrate, and the central conductive pattern and the large annular conductive pattern being electrically connected to another end of the third conductive plate;
a first cable received in the first groove, the first cable having one end electrically connected to the large conductive pattern of the front circuit substrate and another end electrically connected to the large annular conductive pattern of the rear circular circuit substrate;
a second cable received in the second groove, the second cable having one end electrically connected to the small conductive pattern of the front circuit substrate and another end electrically connected to the small annular conductive pattern of the rear circular circuit substrate;
a front cap assembled with the front plate of the cylindrical body to cover the front circuit substrate, the front cap having three holes that have different radii from a center point of the front cap; and
resilient contact terminals configured to resiliently make contact with the conductive patterns through the holes.

8. A flashlight comprising:
a cylindrical body;
a head combined with a front of the cylindrical body, the head including at least one light emitting diode (LED);
a rear cap combined with a rear of the cylindrical body to generate a switching signal; and
a dry cell holder inserted into the cylindrical body and configured to receive three dry cells to provide the head with the switching signal and a power of the dry cells, the dry cell holder including a front plate, a rear plate and a supporting plate integrally formed with one another.

9. The flashlight of claim 8, wherein the head comprises:
a lens holder screwed to the cylindrical body;
a transparent lens installed at the lens holder;
a reflective mirror inserted into the lens holder, the reflective mirror having an end configured to make contact with the transparent lens and holes configured to receive LEDs;
a lamp holder inserted into the lens holder, the lamp holder having an end configured to make contact with the reflective mirror;
a lamp substrate arranged in the lamp holder, the lamp substrate having the LEDs;
a controlling substrate arranged on a bottom surface of the lamp holder and connected to the lamp substrate to selectively drive any one of the LEDs; and
a terminal substrate installed on the lamp holder, the terminal substrate having concentrically arranged three conductive patterns configured to make contact with the dry cell holder, and the conductive patterns being electrically connected to the controlling substrate.

10. The flashlight of claim 9, wherein the LEDs comprise at least two selected from the group consisting of a white illumination LED, a color illumination LED, a laser pointing LED and an on/off illumination LED, and
the controlling substrate comprises a driving circuit for driving the LEDs to display at least two selected from the group consisting of the white illumination, the color illumination, the laser pointing and the on/off illumination responsive to the switching signal applied to any one of the conductive patterns.

11. A flashlight comprising:
a cylindrical body;
a head combined with a front of the cylindrical body, the head including at least one light emitting diode (LED) and a lens linearly moving forward and backward between the LED and a focal point;
a rear cap combined with a rear of the cylindrical body to generate a switching signal; and
a dry cell holder inserted into the cylindrical body and configured to receive three dry cells to provide the head with the switching signal and a power of the dry cells, the dry cell holder including a front plate, a rear plate and a supporting plate integrally formed with one another.

12. The flashlight of claim 11, wherein the head comprises a lens holding portion and a lamp holding portion,
the lens holding portion comprising:
a lens fixing tube having a front portion where a flange is formed and a rear portion where a bolt portion is formed;
a lens holding tube including a nut portion, a locking jaw, a lens holding ring, a bolt portion and a guide rail, the nut portion being formed on a front inner surface of the lens holding tube and screwed to the bolt portion of the lens fixing tube, the locking jaw being formed on an inner surface of the nut portion, the lens holding ring being installed on the locking jaw to secure a convex lens, the bolt portion being formed on a rear outer surface of the lens holding tube, and the guide rail being formed on an inner surface of the lens holding tube; and
a rotating tube including a nut portion and a locking ring, the nut portion being formed on an outer surface of the rotating tube and screwed to the bolt portion of the lens holding tube, and the locking ring being formed on a rear inner surface of the rotating tube,
the lamp holding portion comprising:
a lamp holding tube having a locking jaw and a bolt portion, the locking jaw being formed on a front outer surface of the lamp holding tube, and the bolt portion being formed on a rear outer surface of the lamp holding tube;
a lamp substrate received in the lamp holding tube;
LEDs mounted on the lamp substrate;
a cover ring combined with the lamp holding tube to expose the LEDs;
a terminal substrate received in the lamp holding tube and configured to make contact with the dry cell holder, the terminal substrate including a control circuit connected with the lamp substrate to drive the LEDs; and
a connecting tube having a nut portion, a bolt portion and a guide groove, the nut portion being formed on a front inner surface of the connecting tube and screwed to the bolt portion of the lens holding tube, the bolt portion being formed on a rear outer surface of the connecting tube and screwed to the cylindrical body, and the guide groove being formed at the outer surface of the connecting tube and configured to slidably receive the guide rail of the lamp holding tube, and
wherein the lens holding tube moves forward and backward along the guide groove by rotating the rotating tube.

13. The flashlight of claim 11, wherein the head comprises a lens holding portion and a lamp holding portion,
the lens holding portion comprising a lens holding tube including a nut portion, a locking jaw, a lens holding ring, a bolt portion and a guide rail, the nut portion being formed on a front inner surface of the lens holding tube, the locking jaw being formed on an inner surface of the nut portion, the lens holding ring being installed on the locking jaw to secure a convex lens, the bolt portion being formed on a rear outer surface and screwed to the nut portion of the lens fixing tube, and the guide rail being formed on an inner surface of the lens holding tube,
the lamp holding portion comprising:
a connecting tube having a nut portion, a bolt portion, an upper guide groove, a lower guide groove and a fixing groove, the nut portion being formed on a front inner surface of the connecting tube and screwed to the bolt portion of the lens holding tube, the bolt portion being formed on a rear outer surface of the connecting tube, the upper and lower guide grooves being formed at the outer surface of the connecting tube, the lower guide groove being configured to slidably receive the guide rail of the lamp holding tube, and the fixing groove being formed at the outer surface of the connecting tube adjacent to the upper guide groove; and
a resilient plate having a protruded portion and a bent portion, the protruded portion being formed at one end of the resilient plate and meshed with the upper guide groove of the connecting tube, and the bent portion being formed at another end of the resilient plate and inserted into the fixing groove of the connecting tube, and
wherein the lens holding tube moves forward and backward along the guide grooves, and the protrusion of the resilient plate is selectively inserted into the locking groove of the lens holding tube to generate a sound for adjusting the movement of the lens holding tube.

14. The flashlight of claim 11, wherein the head comprises a lens holding portion and a lamp holding portion,
the lens holding portion comprising:
a lens holding tube including a nut portion, a locking jaw, a lens holding ring, a rack and a guide rail, the nut portion being formed on a front inner surface of the lens holding tube, the locking jaw being formed on an inner surface of the nut portion, the lens holding ring being installed on the locking jaw to secure a convex lens, the rack being formed on a rear outer surface of the lens holding tube, and the guide rail being formed on an inner surface of the lens holding tube; and
a pinion fixing tube having a hole and a locking ring, the hole being formed at an outer surface of the pinion fixing tube, and the locking ring being formed on a rear inner surface of the pinion fixing tube;
a pinion supporting portion screwed to the pinion fixing tube, the pinion supporting portion having a hole and an axial groove, the hole being formed at a central portion of the pinion supporting portion, and the axial groove extending from the hole in left and right directions; and
a pinion meshed with the rack,
the lamp holding portion comprising:
a lamp holding tube having a locking jaw and a bolt portion, the locking jaw being formed on a front outer surface of the lamp holding tube, and the bolt portion being formed on a rear outer surface of the lamp holding tube;
a lamp substrate received in the lamp holding tube;
LEDs mounted on the lamp substrate;
a cover ring combined with the lamp holding tube to expose the LEDs;
a terminal substrate received in the lamp holding tube and configured to make contact with the dry cell holder, the terminal substrate including a control circuit that is connected with the lamp substrate to drive the LEDs; and
a connecting tube having a nut portion, a bolt portion and a guide groove, the nut portion being formed on a front inner surface of the connecting tube and screwed to the bolt portion of the lens holding tube, the bolt portion being formed on a rear outer surface of the connecting tube and screwed to the cylindrical body, and the guide groove being formed at the outer surface of the connecting tube and configured to slidably receive the guide rail of the lamp holding tube, and
wherein the lens holding tube moves forward and backward along the guide groove by the linear movement of the rack.
